(19) United States
(12) Patent Application Publication
(10) Pub. No.: US 2017/0017140 A1
(43) Pub. Date: Jan. 19, 2017

(54) Head-Mounted Camera Apparatus

(71) Applicant: Gusto Technologies, Inc., Golden, CO (US)

(72) Inventor: Shane Schieffer, Superior, CO (US)

(21) Appl. No.: 15/211,943

(22) Filed: Jul. 15, 2016

Related U.S. Application Data
(60) Provisional application No. 62/193,031, filed on Jul. 15, 2015.

(51) Int. Cl. G03B 17/56; F16M 11/12; A45F 5/00; F16M 13/02

(52) U.S. Cl. CPC G03B 17/561; F16M 13/02; F16M 11/126; A45F 5/00; F16M 2200/041

(57) ABSTRACT

A camera mount includes an arm. The arm has an attachment mechanism at one end of the arm for attaching the arm to a helmet. The arm extends downward in a substantially vertical direction from the helmet when attached via the attachment mechanism to the helmet. The arm has a second attachment mechanism at an opposite end of the arm for attaching the arm to a camera, such that the camera is positioned below a head of a body when attached via the second attachment mechanism to the camera and when the helmet is positioned on the head of the body.

### CROSS-REFERENCE TO RELATED APPLICATIONS

This application claims the benefit of U.S. Provisional patent application No. 62/193,031, filed Jul. 15, 2015, the entire contents of which are incorporated by reference herein.

### TECHNICAL FIELD

Embodiments of the present invention relate to a head-mounted video camera.

### BACKGROUND

Traditional head-mounted cameras, including those capable of shooting video, pictures, or both, mount a camera to the side or top of the head, as seen in FIGS. 1A and 1B. Recently, a chest-mount (mounting the camera to the torso) has been introduced (not shown). Other camera mount systems include an inertia-driven hand held device (similar to a Steadicam), a gyroscope-stabilized camera (typically mounted on a helicopter), and a robotic stabilized device (using accelerometers and brushless motors). However, the head is generally considered to be the best place to get a first-person, or Point of View (POV) shot. The head is often times the most stable body part during activity. However, the weight of a camera mounted on the side or the top of the head causes the camera to act as a lever arm that is affected by gravity and movement. In FIG. 1A, for example, a camera mounted on the side of the head creates two directions (1, 2) of leverage. Alternatively, one can add a counter-weight to the other side of the head, opposite the side on which the camera is mounted, to reduce one axis of wobble, but at the cost of increased neck strain. In FIG. 1B, for example, a camera mounted on the top of the head creates a lever arm, and the head then becomes a fulcrum around which the camera pivots to the left or right, de-stabilizing the camera. In FIG. 1C, with the camera mounted at the bottom of a helmet, a short lever arm is effectively created, which is insufficient to provide a stabilizing effect. Horizontal displacement of the camera about the fulcrum at the bottom of the helmet creates wobble in video footage. Thus, as illustrated, mounting the camera on the side or the top of the head actually increases shaking or movement of the head during activity as compared to the head alone.

What is needed is a head-mounted camera system in which the weight of the camera will act as a force at the end of a lever arm that effectively reduces the motion of the head and stabilizes the camera and, through inertia, provides better video and pictures than traditional head-mounted camera systems.

### SUMMARY

A camera mount that suspends a camera below a head of a body such that the weight and position of the camera creates greater stability, and slows movement of the camera relative to movement of the head.

### BRIEF DESCRIPTION OF THE DRAWINGS

Embodiments are illustrated by way of example, and not by way of limitation, and can be more fully understood with reference to the following detailed description when considered in connection with the figures in which:

FIGS. 1A, 1B and 1C illustrate prior art head-mounted camera systems.

FIGS. 2A, 2B, 2C and 2D illustrate embodiments of the invention.

### DETAILED DESCRIPTION

Embodiments of the invention provide for a way to attach a camera to the head (using a helmet, a hat, a strap, etc.).

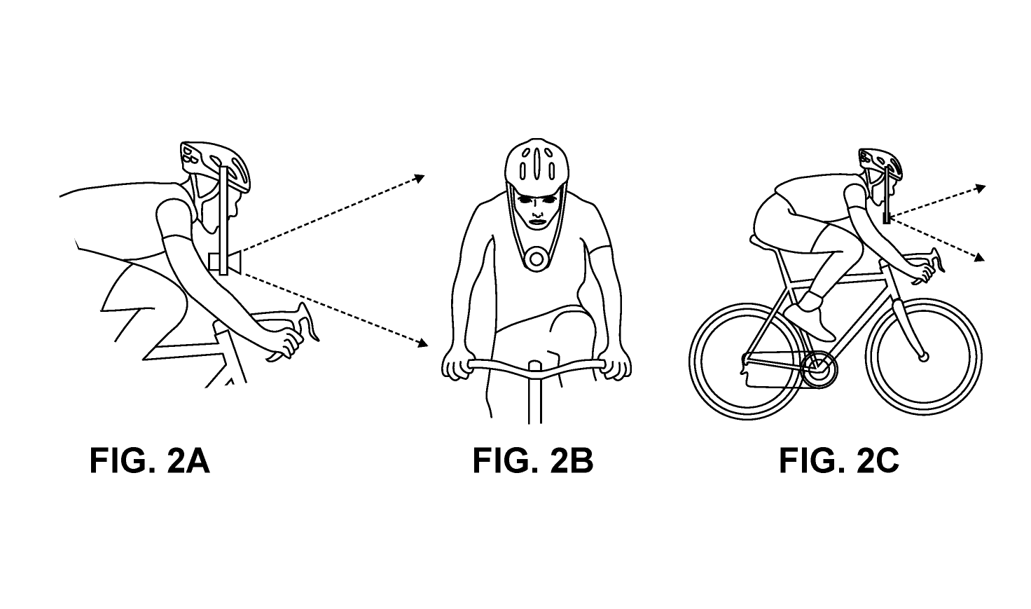

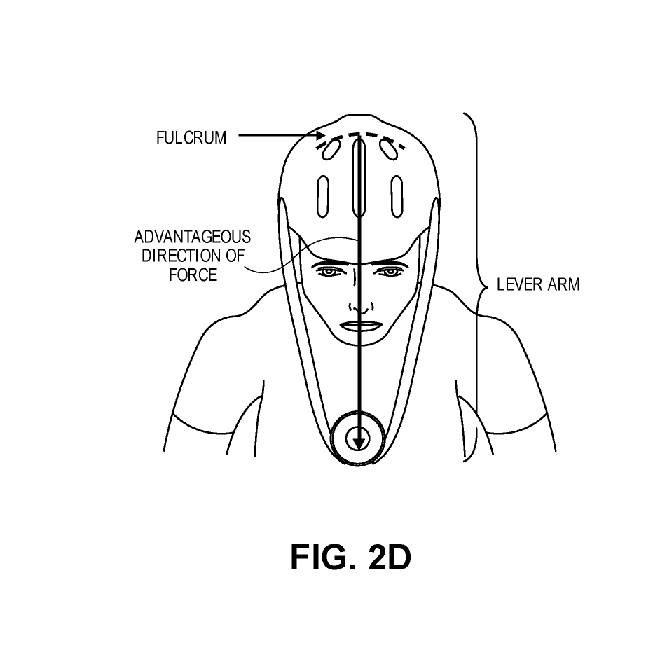

In one embodiment, as illustrated in FIGS. 2A, 2B, 2C and 2D, a rigid or semi-rigid arm extends from the head in a downward direction, providing a platform on which a camera can be mounted below the head. In the embodiments illustrated in FIGS. 2B and 2D, a pair of rigid or semi-rigid arms are depicted, attaching at opposite sides of a helmet and extending downward to below the chin of a person. In one embodiment, the pair of arms may extend to the torso or midsection of a body. In another embodiment, only a single rigid or semi-rigid arm may extend from either the left or right side of the helmet. In yet another embodiment in which a helmet includes a wrap around chin component or strap, the arm(s) may extend from the chin component or strap. In one embodiment, the arm(s) may be a fixed length. In another embodiment, the arm(s) may be adjustable and/or of variable length. For example, the arm(s) may comprise one or more telescoping or sliding members that allow for adjusting the extent of overlap between the sliding members and locking in place the overall length of the arm(s).

In another embodiment, the arm(s) may be fixedly pivotable at the point of attachment to the helmet, and/or at the point of attachment to a camera. While the embodiment illustrated in FIGS. 2A-2D depict a bicycle helmet, one skilled in the art can appreciate that an embodiment of the invention may attach to any type of helmet. In one embodiment, the arm(s) may be manufactured as an integrated component with a helmet. In other embodiments, the arm(s) may be after-market components or accessories that attach to the helmet at attachment points or receptacles provided for by the helmet manufacturer or after-market manufacturer. In one embodiment, the arm(s) may attach to a hard-shell helmet made of a rigid structure, while in other embodiments, the arm(s) may attach to a soft-shell helmet, cloth, knit or woven-fabric cap, or elastic or inelastic straps, adapted for placement on the head. In embodiments, the arm(s) may attach to a point or area of attachment on the helmet/hat/cap/strap, and to a point or area of attachment on the camera, by way of screw, snap, clip, or other mechanical based attachment or fastening product, including fabric hook and loop fasteners (such as Velcro®), positioned at each end of the arm(s). In another embodiment, the attachment of the arm(s) to the helmet/hat/cap/strap may involve using magnets and/or interlocking shapes that allow the arm(s) to be quickly affixed to, or removed from, the helmet/hat/cap/strap.

Embodiments of the invention put into advantage many factors that are at play when trying to get stable footage with a camera. These include:

The View is Centered:

Camera footage is best centered because any view of the person or their activity is best represented from a central viewpoint. When the view is centered, or substantially centered, handlebars or other items in the frame appear as a person experiences it, as opposed to being offset to the side.

The View is Low:

Action shots typically use a wide-angle lens to capture the view because human vision is near 180-degrees, whereas a traditional camera lens only captures about a 70-degree view (less than half). The difficulty with a wide-angled lens is that it distorts distance such that close objects appear very large and objects in the medium-distance appear much smaller than their actual relative sizes. A person can better “feel” the action in a video when the parts of the footage that are moving (ground, bushes, rocks) are larger on the screen. More often than not the action in the video is below the lens (the ground), not above it (the sky). Given the distortion of a wide-angle lens and the corresponding need to have the camera close to the action it is best to have a POV camera in a lower position.

The Weight (and Strain) is Less:

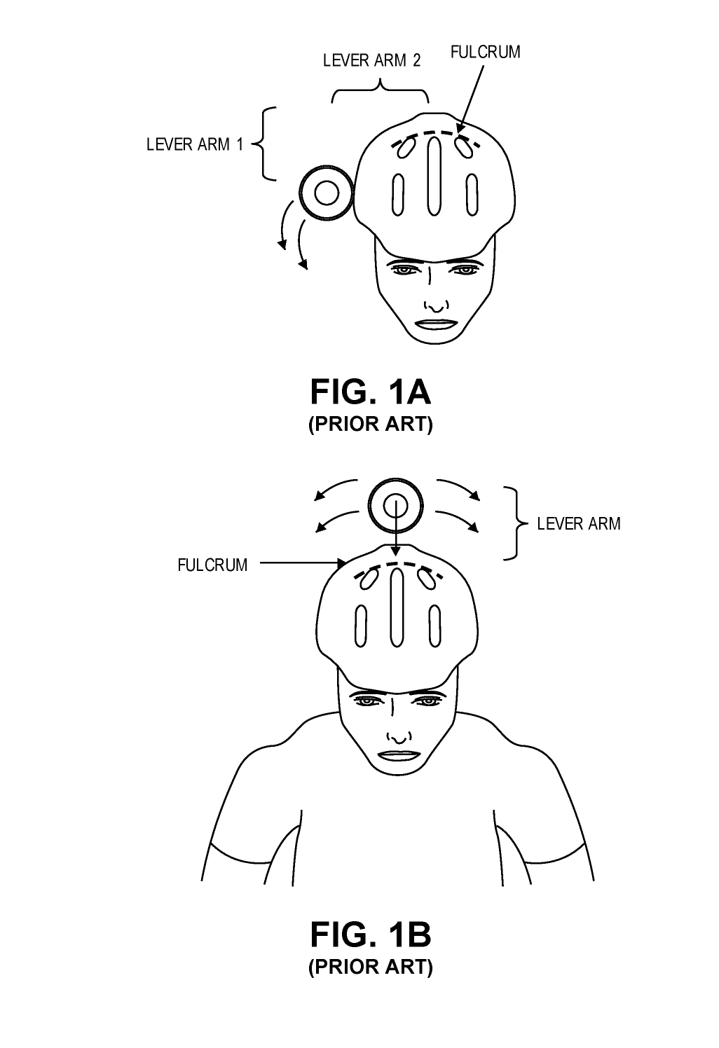

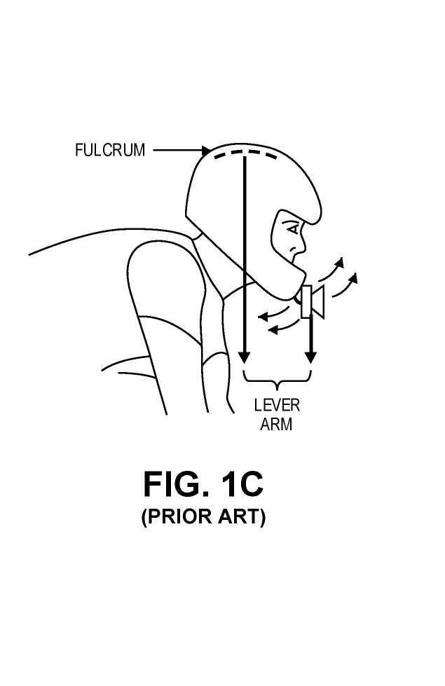

Mounting a camera on the side of the head, as in the prior art (FIG. 1A) causes the weight of the camera to act as a lever against the apparatus that is attached to the head (a helmet, for example). This, in turn, causes horizontal tilt and wobble in the picture. This can be compensated for by adding a, preferably equal, weight to the other side of the head. The centralized placement of the camera according to embodiments of the invention removes the need for such a weight—allowing a cameraman to experience less strain or use larger and more complex cameras than otherwise possible or desired.

The Weight Becomes a Stabilizing Force:

Because the center-of-gravity of a camera mounted according to an embodiment of the invention is at a distance from the head itself, the weight of the camera becomes a force applied at the end of the lever. With reference to FIG. 2D, by placing the camera directly below the head (fulcrum) a certain distance, this leverage is naturally applied to stabilize the camera (it wants to be center and bottom). The lever itself is the distance (length of the arm(s)) from the fulcrum to the camera. Further, all head mounts have some degree of movement between the camera mount and the head itself. When the camera operator experiences jarring movement and vibration, then inertia from the weight of the camera overcomes the friction of the helmet (or hat, or strap(s)) on the head and allows the camera to move less than the head. (The head moves in the helmet, but the helmet does not move because of the added weight imparted by the camera.) Given that the head generally is already the most stable part of the human body during activity, this means embodiments of the invention provide for more stable camera footage.

The Weight Naturally Levels the Camera Relative to the Horizon:

The natural “home” position of the camera becomes bottom and center, which levels the camera mount to the horizon. Thus, inadvertent tilt (looking up and down) of the head is neutralized.

You can Use the Tripod Screw:

Cameras often have tripod screens underneath them. These are built as structural supports for the camera. By mounting a camera as it is intended the camera itself is less prone to movement and/or damage.

Tilt and Pan Control:

Cameras (especially large cameras) mounted to the to the head tend to be fixed on either the tilt (vertical movement) or pan (horizontal turning) axis. However, embodiments of the invention can adjust tilt where the camera mount meets the helmet and pan at the point where the camera is mounted to the device.

Movement and Vibration Work Better with Optically Stabilized Cameras:

Many cameras on the market use optical stabilization (which involves the physical movement of the camera lens in opposition of the camera's movement) to stabilize an image during filming. These sensors and motors have speed limitations. They cannot react to high speed jostling or vibrations. A benefit of embodiments of the invention is transforming high frequency movement into lower frequency movement and thereby allowing optical stabilization of the camera to more effectively remove or reduce camera shake.

Movement and Vibration Work Better with Digitally Stabilized Camera and/or Digital Stabilization in Post-Production:

Similar to the above noted advantage that movement and vibration work better with optically stabilized cameras, lower frequency (even at bigger amplitudes) camera shake is preferable to higher frequency movement. In this case it is because with high-frequency vibration each frame of video will be blurred under sudden movement. Digital stabilizing can effectively remove the change in position, rotation and scaling of footage; but it cannot remove blur, thus the footage appears rough and unprofessional. Embodiments of the invention transform sudden jolts into a slower movement that is better captured without blur and more easily handled by digital stabilization techniques.

In an alternative embodiment, the camera can be mounted upside down if that makes a preferable mounting platform (and then the footage flipped right-side-up in post-production). In another embodiment, a secondary stabilizing apparatus may be used between the camera mount and the camera (for example a robotic stabilization) for additional stabilization. In one embodiment, the secondary stabilizing apparatus may be robotic stabilization. In another embodiment, the secondary stabilizing apparatus may be one or more gyroscopic gimbal(s). In such an embodiment, the gimbal(s) may be situated at the point where the arm(s) attach the helmet and/or at the point where the arm(s) attach to the camera.

What is claimed is:

1. An apparatus, comprising:
a camera mount that suspends a camera below a head of a body such that the weight and position of the camera is stabilized, and reduces movement of the camera from movement of the head.

2. The apparatus of claim 1, wherein the camera mount is a rigid or semi-rigid arm to which a camera can be attached.

3. The apparatus of claim 2, wherein the arm includes an attachment mechanism for attachment to the camera.

4. The apparatus of claim 1, wherein the camera mount is a rigid or semi-rigid arm capable of attachment to a helmet.

5. The apparatus of claim 4, wherein the arm includes an attachment mechanism for attachment to the helmet.

6. A camera mount, comprising:
an arm, the arm having a first attachment mechanism at a first end of the arm for attaching the arm to a point of attachment on a helmet, the arm extending downward in a substantially vertical direction from the helmet when attached via the first attachment mechanism to the point of attachment on the helmet, the arm having a second attachment mechanism at a second end of the arm for attaching the arm to a point of attachment on a camera, such that the camera is positioned below a head of a body when attached via the second attachment mechanism to the point of attachment on the camera and when the helmet is positioned on the head of the body.

7. The camera mount of claim 6, further comprising a second arm, the second arm having a first attachment mechanism at a first end of the second arm for attaching the second arm to a second point of attachment on the helmet, the second arm extending downward in a substantially vertical direction from the helmet when attached via the first attachment mechanism to the second point of attachment on the helmet, the second arm having a second attachment mechanism at a second end of the second arm for attaching the second arm to a second point of attachment on the camera, such that the camera is positioned below the head of the body when attached via the second attachment mechanism to the second point of attachment on the camera and when the helmet is positioned on the head of the body.

8. The camera mount of claim 7, wherein the first and second point of attachment on the camera is a common point of attachment.

9. The camera mount of claim 7, wherein the camera positioned below the head of the body comprises the camera substantially centered below the head of the body.

10. The camera mount of claim 6, further including a stabilizing device to couple the camera mount to the camera.

11. The camera mount of claim 10, wherein the stabilizing device is a robotic stabilization device.

12. The camera mount of claim 10, wherein the stabilizing device is a gyroscopic gimbal.

13. The camera mount of claim 6, further including a stabilizing device to couple the camera mount to the helmet.

14. The camera mount of claim 13, wherein the stabilizing device is a robotic stabilization device.

15. The camera mount of claim 13, wherein the stabilizing device is a gyroscopic gimbal.
